(19) United States
(12) Patent Application Publication
(10) Pub. No.: US 2023/0252388 A1
(43) Pub. Date: Aug. 10, 2023

(54) COMPUTERIZED SYSTEMS AND METHODS FOR INTELLIGENT LISTENING AND SURVEY DISTRIBUTION

(71) Applicant: WORKDAY, INC., Pleasanton, CA (US)

(72) Inventors: Klaudia AMBROZIAK, London (GB); Joe CAINEY, London (GB); Gary ENGELBERT, London (GB)

(21) Appl. No.: 17/592,671

(22) Filed: Feb. 4, 2022

(51) Int. Cl. G06Q 10/06; G06N 7/00

(52) U.S. Cl. CPC G06Q 10/0637; G06N 7/00

(57) ABSTRACT

Disclosed are systems and methods for an intelligent listening framework that is configured to dynamically generate surveys based at least on predicted answers to questions that may potentially be included in a survey. The disclosed framework is configured to determine which questions will derive disparate answers from a respondent or set of respondents. This enables the solicitation and collection of viable data that can drive an entity’s resource optimization and/or business development. As more and more engaging and viable forms of answers are received, surveys can be customized to types of respondents, which can be based on any form of information that can discern one respondent from another.

### BACKGROUND

Surveys serve as important resources for entities (e.g., companies) and their managers (e.g., administrators) to collect information from parties (e.g., users or employees, referred to as respondents). In certain circumstances, surveys can be used to drive productivity and enable better decision making.

### SUMMARY

Presently known systems for generating and distributing surveys fall short of establishing solutions that capitalize on identifying what types of questions and/or what types of information within a survey actually drives respondent interaction, both in a timely and truthful manner. For example, current solutions simply enable the manual selection of questions for inclusion in surveys.

The systems and methods disclosed herein provide an improved and dynamically applied intelligent listening framework. The disclosed framework, as discussed in more detail below, is configured to dynamically generate surveys based at least on predicted answers to questions that are identified for inclusion in a survey. That is, the disclosed framework is configured to determine which questions will derive disparate answers from a respondent or set of respondents. This enables the collection of viable answers that can drive an entity’s resource optimization and/or business development. As more and more engaging and viable forms of answers are received, surveys can be customized to types of respondents, which can be based on their job title, department, demographics, geographies, or any other form of information that can discern one respondent from another.

In accordance with one or more embodiments, the present disclosure provides computerized methods for an intelligent listening framework that dynamically determines and distributes surveys to users that include questions that are predicted to solicit disparate, viable forms of information from each user.

In accordance with one or more embodiments, the present disclosure provides a non-transitory computer-readable storage medium for carrying out the above mentioned technical steps of the framework’s functionality. The non-transitory computer-readable storage medium has tangibly stored thereon, or tangibly encoded thereon, computer readable instructions that when executed by a device (e.g., a client device) cause at least one processor to perform a method for an intelligent listening framework that dynamically determines and distributes surveys to users that include questions that are predicted to solicit disparate, viable forms of information from each user.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary data flow according to some embodiments of the present disclosure;

FIG. 4 illustrates a non-limiting example chart of collected data for performing intelligent listening processing according to some embodiments of the present disclosure;

FIG. 5 is a block diagram illustrating a computing device showing an example of a client or server device used in various embodiments of the present disclosure.

### DETAILED DESCRIPTION OF EXAMPLE EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server.

For purposes of this disclosure, a client (or consumer or user) device, referred to as user equipment (UE)), may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device (UE) may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

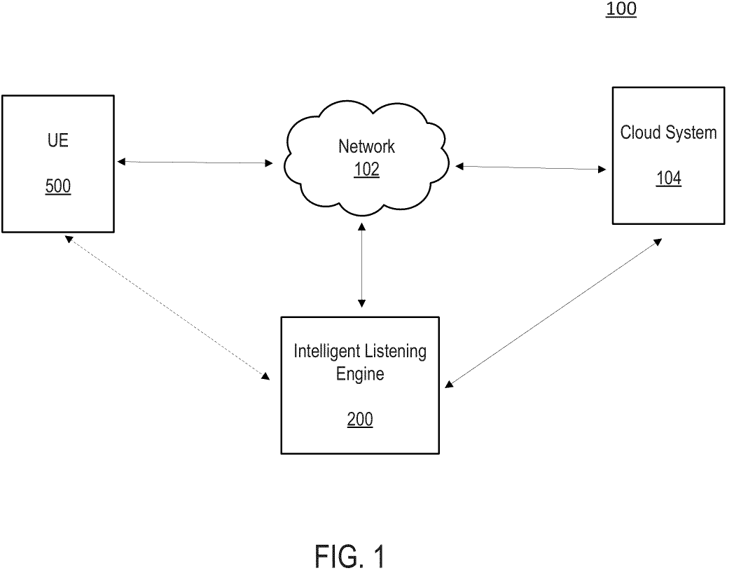

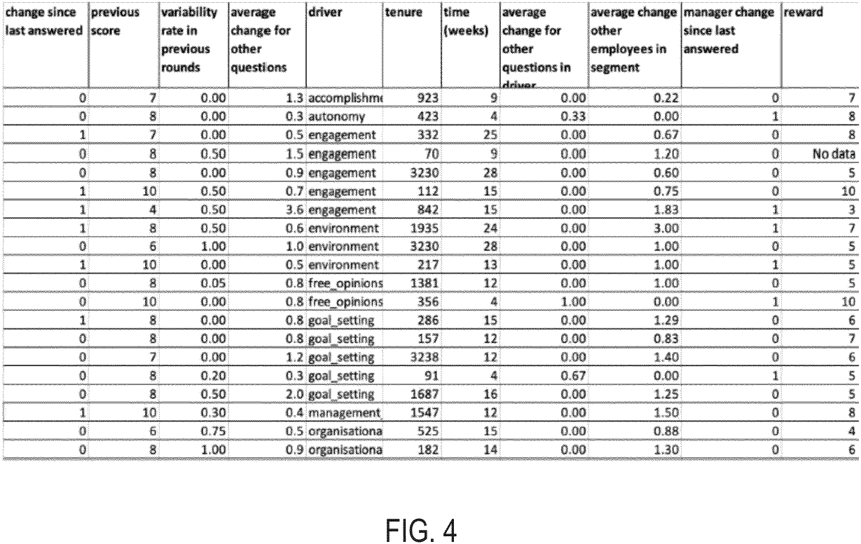

With reference to FIG. 1, system 100 is depicted which includes UE 500 (e.g., a client device, as mentioned above), network 102, cloud system 104 and intelligent listening engine 200. UE 500 can be any type of device, such as, but not limited to, a mobile phone, tablet, laptop, sensor, Internet of Things (IoT) device, autonomous machine, and any other device equipped with a cellular or wireless or wired transceiver. Further discussion of UE 500 is provided below in reference to FIG. 4.

Network 102 can be any type of network, such as, but not limited to, a wireless network, cellular network, the Internet, and the like (as discussed above). Network 102 facilitates connectivity of the components of system 100, as illustrated in FIG. 1.

Cloud system 104 can be any type of cloud operating platform and/or network based system upon which applications, operations, and/or other forms of network resources can be located. For example, system 104 can be a service provider and/or network provider from where services and/or applications can be accessed, sourced or executed from. In some embodiments, cloud system 104 can include a server(s) and/or a database of information which is accessible over network 102. In some embodiments, a database (not shown) of cloud system 104 can store a dataset of data and metadata associated with local and/or network information related to a user(s) of UE 500 and/or the UE 500, and the services and applications provided by cloud system 104 and/or intelligent listening engine 200.

Intelligent listening engine 200, as discussed above and below in more detail, includes components for optimizing how surveys or assessments are compiled and distributed to participating users, and thereby maximizing the types and quantity of viable information from such surveys. According to some embodiments, intelligent listening engine 200 can be a special purpose machine or processor and could be hosted by a device on network 102, within cloud system 104 and/or on UE 500. In some embodiments, engine 200 can be hosted by a peripheral device connected to UE 500.

According to some embodiments, as discussed above, intelligent listening engine 200 can function as an application provided by cloud system 104. In some embodiments, engine 200 can function as an application installed on UE 500. In some embodiments, such application can be a web-based application accessed by UE 500 over network 102 from cloud system 104 (e.g., as indicated by the connection between network 102 and engine 200, and/or the dashed line between UE 500 and engine 200 in FIG. 1). In some embodiments, engine 200 can be configured and/or installed as an augmenting script, program or application (e.g., a plug-in or extension) to another application or program provided by cloud system 104 and/or executing on UE 500.

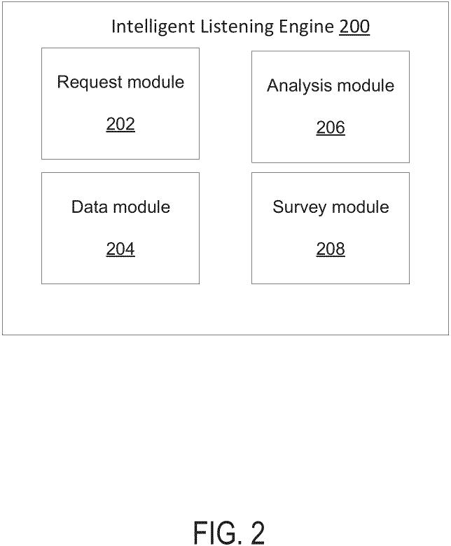

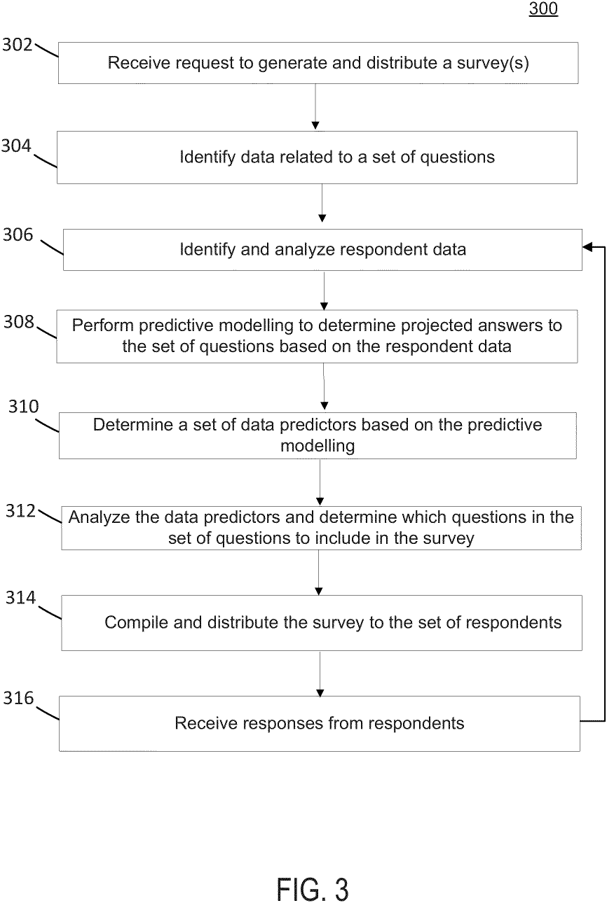

As illustrated in FIG. 2, according to some embodiments, intelligent listening engine 200 includes request module 202, data module 204, analysis module 206 and survey module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below in relation to FIG. 3.

FIG. 3 provides Process 300 which details non-limiting example embodiments of the disclosed intelligent listening framework’s operations of dynamically determining and distributing surveys to users that include questions that are predicted to solicit disparate, viable forms of information from each user.

According to some embodiments, Step 302 can be performed by request module 202 of intelligent listening engine 200; Steps 304-306 can be performed by data module 204; Steps 308-312 can be performed by analysis module 206; and Steps 314-316 can be performed by survey module 208.

Process 300 begins with Step 302 where a request to generate and distribute a survey(s) is received. In some embodiments, the request can be in relation to a user request, or automatically triggered based on a timing cadence (e.g., send a survey to a set of users every quarter, for example). In some embodiments, the request can be specific to a particular respondent, or a set of respondents (e.g., a segment or department within a company).

For purposes of this discussion, the request and the processing steps of Process 300 discussed herein will be in reference to generating a survey for a set of users (i.e., a set respondents, for example, a department within a company). As such, the request can include information identifying each respondent in the set of respondents. This should not be construed as limiting, as it should be readily understood that a plurality of surveys can be generated for a plurality of respondents, as well as individualized surveys per particular respondents in a similar manner.

In Step 304, data related to a set of questions (e.g., question data) can be identified. In some embodiments, the question data can be extracted, retrieved or otherwise identified from a data store of question data from previous surveys; and in some embodiments, the question data can correspond to newly generated questions that have yet to be included in a survey; or some combination thereof.

In some embodiments, question data can be identified based on a variety of factors including, but not limited to, information provided by the party requesting the survey be completed (e.g., the party triggering the request in Step 302, which can include a topic, context or directive for types and/or quantity of questions (e.g., a “driver”, as discussed below)), information related to an identity of the set of respondents, a previously derived and/or determined behavior of the respondents, and/or any other type of information that can drive types of questions to be included in survey.

According to some embodiments, Step 304 can involve analyzing the request, and/or any of the information related to the factors discussed above, by applying a machine learning (ML) or artificial intelligence (AI) algorithm (e.g., classifier, data mining model, neural network, natural language processor (NLP), and the like), and as a result, determining which questions for potential inclusion to the survey.

In Step 306, respondent data related to the set of respondents identified in the request can be analyzed. According to some embodiments, respondent data can include, but is not limited to, data collected for a respondent from previous surveys, data related to the job, position or department of the respondent, or other form of demographic, geographic or identifying information related to the respondent. According to some embodiments, this data can be identified (from the request and/or retrieved from a data store of respondent data) and then analyzed to determine applicability to a set of questions (as discussed below in at least Step 308).

According to some embodiments, analysis of the respondent data can provide information related to the behaviors of each respondent from previously interacted with surveys. For example, the respondent data can provide indicators as to which questions are typically answered, which are ignored, time lapses since a respondent last provided survey answer(s), time lapses since a respondent last provided an answer to a same or similar question of a survey, how long it takes a respondent to answer a survey, how frequently they are pinged to respond to a survey, the context of their answers to particular types of questions, and the like. In some embodiments, such analysis can be performed according to any type of known or to be known ML/AI algorithm, as discussed above.

In some embodiments, a result of the analysis of the respondent data can include scores or other metrics that indicate, but are not limited to, answered questions, unanswered questions, how long answers took to be provided, the content/context of the answer, and the like, or some combination thereof. According to some embodiments, the analysis/scoring of the respondent data can be performed via the ML/AI models discussed above, among others, which can provide behavioral data for each respondent.

In Step 308, engine 200 performs predictive modelling on the identified questions based on the analyzed respondent data to determine projected (or predicted) answers to each question. That is, engine 200 provides the question data and the respondent data as input to a predictive modelling algorithm, which can then compute projected answers for each question (e.g., predicted answers by each respondent to the questions based on their respondent data). According to some embodiments, the predictive modelling algorithm can be any suitable algorithm such as, but not limited to, a random forest model, a logistic regression model, a Support Vector Machine (SVM), a neural network(NN), and the like.

In Step 310, engine 200 can determine a set of data predictors, which can be based on the predictive modelling of Step 308. According to some embodiments, data predictors can provide an indication of metrics that indicate differences between a respondent’s survey behavior (e.g., how particular questions are predicted to be answered versus how they were answered in the past (e.g., from the respondent data)).

According to some embodiments, the data predictors can include, but are not limited to, “previous score”, variability rate”, “average change for other questions”, “driver”, “tenure”, “time” (e.g., weeks), “average change for other questions in driver”, “average change for other employees in segment”, and “manager change”. These data predictors can be resultant from the output of the predictive modelling of Step 308.

Such data predictors and non-limiting example scoring values for such predictors are illustrated in FIG. 4, which depicts a chart for a particular respondent and the data predictors for a plurality of questions, where each row corresponds to a particular question for the respondent.

According to some embodiments, the data predictor “previous score” can indicate the previous score of a particular question and/or its answer.

According to some embodiments, the data predictor “variability rate” can provide a historical variability for a particular respondent (e.g., how differently the respondent answered the question over past surveys).

According to some embodiments, the data predictor “average change for other questions” can indicate a change in scores for other questions in the same round (or same survey).

According to some embodiments, the data predictor “driver” can correspond to a context, topic or other metric/variable that indicates how engaging the respondent has been with a particular question or type of question. The driver can also, or alternatively correspond to a cause, reasoning, timing, or purpose of a question (e.g., what type of information is the question attempting to gain).

According to some embodiments, the data predictor “employee tenure” can correspond to how long the respondent worked at a company. According to some embodiments, this can be in weeks, years, months, or any other metric that indicates how long an employee has worked for a company (or at a particular position or within a particular department, and the like).

According to some embodiments, the data predictor “time” can correspond to the time since the same question was last answered by a respondent. Similar to “employee tenure”, this metric can be in days, weeks, months, years, and/or any other metric.

According to some embodiments, the data predictor “average change for other questions in driver” can correspond to an average change in scores for that driver in a round of surveys.

According to some embodiments, the data predictor “average change for other employees in segment” can correspond to an average change in scores for other employees in the same round.

According to some embodiments, the data predictor “manager change” can correspond to whether a respondent’s manager has changed since a question was last answered, since a survey was issued, and/or any other type or timing of change in management for the respondent since providing a response to a question/survey.

According to some embodiments, the data predictor “reward” specifies one of the drivers of engagement in the engagement model and stands for the most recent score given to the “reward” question. Other drivers of engagement can also be included as well. That is, the above data predictors are for a specific question, and the “reward” provides indicators of how a respondent was scored for other questions.

In Step 312, engine 200 can analyze (e.g., via the ML/AI techniques discussed above) the data predictors and determine which question to include in a survey for each respondent. Step 312′s question identification and selection operation involves identifying questions that are more likely to elicit random or different responses from respondents (e.g., different responses per respondent or an indicated likelihood that the questions will be answered and that they will elicit responses that are not expected and/or rudimentary, and therefore are compliant with the purposes of the survey). Thus, Step 312 can involve identifying a subset of questions from the set of questions (from Step 304) based on a variability from the data prediction metrics across respondents (e.g., if a data predictor value is above a threshold, then it can indicate a viable question to include in the survey).

In Step 314, having determined the questions to include in a survey (from Step 312), engine 200 can compile this information into an electronic survey and distribute/communicate an indication to the set of respondents that a survey is being requested to be completed.

In some embodiments, the distribution/communication can comprise a link for a respondent to click to cause the survey to be opened. In some embodiments, the compiled survey can be electronically communicated to the respondents in any electronic form (e.g., email, SMS, and the like).

According to some embodiments, in Step 316, upon receiving responses from the respondents, Process 300 can recursively return to Step 306, where the results of the survey can be analyzed in a similar manner as discussed above, whereby the new surveys can be generated and questions selected for subsequent survey rounds based on updates respondent data (from Step 316′s response data).

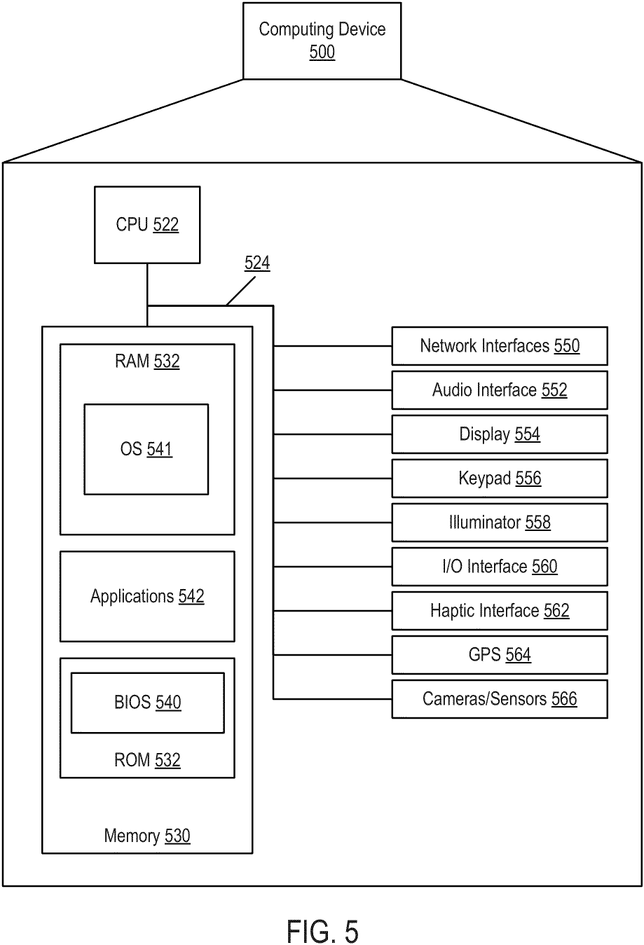

FIG. 5 is a block diagram illustrating computing device 500 (from FIG. 1, discussed above) showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a central processing unit (CPU) 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional GPS receiver 564 (and/or an interchangeable or additional GNSS receiver) and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a request to generate a survey, the request comprising information identifying a set of respondents;
identifying, by the device, question data related to a set of questions;
analyzing, by the device, data related to the set of respondents, and determining a behavior for each respondent in the set of respondents, the behavior corresponding to past activity related to at least one previously interacted with survey;
performing predictive modelling, by the device, based on the question data and the determined behavior for each respondent, the predictive modelling comprising a determination of projected answers to each of the questions in the set of questions by each respondent;
determining, by the device, based on the predictive modelling, data predictors for each question in the set of questions for each respondent, the data predictors indicating differences in a respondent’s survey behavior between the projected answers and the past activity;
determining, by the device, a subset of questions from the set of questions based on the data predictors;
compiling, by the device, an electronic survey for the set of respondents, the compiled survey comprising the subset of questions.

2. The method of claim 1, further comprising:
communicating, by the device, the electronic survey to each respondent in the set of respondents; and
receiving, by the device, a response from each respondent in the set of respondents.

3. The method of claim 2, further comprising:
updating the data related to the set of respondents based on the responses from each respondents, wherein the updated data is utilized to response to subsequent requests for survey generation.

4. The method of claim 1, further comprising:
performing the predictive modelling by applying an algorithm to the question data and the respondent data; and
outputting the data predictors based on the application of the random forest algorithm.

5. The method of claim 1, wherein the data predictors correspond to metrics that indicate a scoring of a respondent’s survey behavior.

6. The method of claim 5, further comprising:
analyzing, by the device, the scoring of the data predictors for each respondent; and
determining, by the device, the subset of questions based on variability within the scoring as indicated by the analysis.

7. The method of claim 1, wherein the determined behavior for each respondent can correspond to at least one of a scoring that indicates answered questions, unanswered questions, time lapses since each respondent last provided an answer to a survey, time lapses since each respondent last provided an answer to a same or similar question of a survey, and the content or context of an answer.

8. The method of claim 1, wherein the request further comprises information related to a context of the survey.

9. The method of claim 8, further comprising:
analyzing, by the device, the request and identifying the context; and
identifying the set of questions based on the identified context.

10. The method of claim 1, wherein the question data and respondent data is stored in a data store accessible by the device.

11. A non-transitory computer-readable medium tangibly encoded with instructions, that when executed by a processor of a device, perform a method comprising:
receiving, by the device, a request to generate a survey, the request comprising information identifying a set of respondents;
identifying, by the device, question data related to a set of questions;
analyzing, by the device, data related to the set of respondents, and determining a behavior for each respondent in the set of respondents, the behavior corresponding to past activity related to at least one previously interacted with survey;
performing predictive modelling, by the device, based on the question data and the determined behavior for each respondent, the predictive modelling comprising a determination of projected answers to each of the questions in the set of questions by each respondent;
determining, by the device, based on the predictive modelling, data predictors for each question in the set of questions for each respondent, the data predictors indicating differences in a respondent’s survey behavior between the projected answers and the past activity;
determining, by the device, a subset of questions from the set of questions based on the data predictors;
compiling, by the device, an electronic survey for the set of respondents, the compiled survey comprising the subset of questions.

12. The non-transitory computer-readable medium of claim 11, further comprising:
communicating, by the device, the electronic survey to each respondent in the set of respondents; and
receiving, by the device, a response from each respondent in the set of respondents.

13. The non-transitory computer-readable medium of claim 12, further comprising:
updating the data related to the set of respondents based on the responses from each respondents, wherein the updated data is utilized to response to subsequent requests for survey generation.

14. The non-transitory computer-readable medium of claim 11, further comprising:
performing the predictive modelling by applying an algorithm to the question data and the respondent data; and
outputting the data predictors based on the application of the algorithm.

15. The non-transitory computer-readable medium of claim 11, further comprising:
analyzing, by the device, the data predictors for each respondent, wherein the data predictors correspond to metrics that indicate a scoring of a respondent’s survey behavior; and
determining, by the device, the subset of questions based on variability within the scoring as indicated by the analysis.

16. A device comprising:
a processor configured to:
receive a request to generate a survey, the request comprising information identifying a set of respondents;
identify question data related to a set of questions;
analyze data related to the set of respondents, and determine a behavior for each respondent in the set of respondents, the behavior corresponding to past activity related to at least one previously interacted with survey;
perform predictive modelling, by the device, based on the question data and the determined behavior for each respondent, the predictive modelling comprising a determination of projected answers to each of the questions in the set of questions by each respondent;
determine, based on the predictive modelling, data predictors for each question in the set of questions for each respondent, the data predictors indicating differences in a respondent’s survey behavior between the projected answers and the past activity;
determine a subset of questions from the set of questions based on the data predictors;
compile an electronic survey for the set of respondents, the compiled survey comprising the subset of questions.

17. The device of claim 16, further comprising:
communicate the electronic survey to each respondent in the set of respondents; and
receive a response from each respondent in the set of respondents.

18. The device of claim 17, further comprising:
update the data related to the set of respondents based on the responses from each respondents, wherein the updated data is utilized to response to subsequent requests for survey generation.

19. The device of claim 16, further comprising:
perform the predictive modelling by applying an algorithm to the question data and the respondent data; and
output the data predictors based on the application of the algorithm.

20. The device of claim 16, further comprising:
analyze the data predictors for each respondent, wherein the data predictors correspond to metrics that indicate a scoring of a respondent’s survey behavior; and
determine the subset of questions based on variability within the scoring as indicated by the analysis.
